(19) United States
(12) Patent Application Publication
(10) Pub. No.: US 2017/0085765 A1
(43) Pub. Date: Mar. 23, 2017

(54) APPARATUS FOR IMPROVING IMAGE QUALITY, DIGITAL PHOTOGRAPHY APPARATUS HAVING SAME, AND METHOD FOR IMPROVING IMAGE QUALITY

(71) Applicant: MSYS INC., Suwon-si, Gyeonggi-do (KR)

(72) Inventor: Hakrim CHOI, Yongin-si, Gyeonggi-do (KR)

(73) Assignee: MSYS INC., Suwon-si, Gyeonggi-do (KR)

(21) Appl. No.: 15/310,446

(22) PCT Filed: Jul. 23, 2014
(86) PCT No.: PCT/KR2014/006672

§ 371 Date: Nov. 11, 2016

(30) Foreign Application Priority Data
May 21, 2014 (KR) 10-2014-0060780

(51) Int. Cl. H04N 5/238; H04N 5/225; G02F 1/133; H04N 5/33; G02F 1/163; H04N 9/04; H04N 5/235

(52) U.S. Cl. CPC H04N 5/238; H04N 9/045; H04N 5/2254; H04N 5/2351; H04N 5/33; G02F 1/163; G02F 1/13318; H04N 2209/041; G02F 2203/18; G02F 2203/66

(57) ABSTRACT

Disclosed is an image quality improving apparatus, a digital photography apparatus having same, and a method for improving image quality, the image quality improving apparatus comprising: a zone-collected reduction filter (ZRF) which is disposed between a lens unit and an image sensor to let light which has penetrated the lens unit to penetrate and be irradiated on the image sensor, and by means of which the light penetration rate for every multiply partitioned area is controlled; an image processing unit for processing an image acquired by the image sensor into data; and a ZRT control unit for calculating the brightness of plurality of areas, into which the image has been partitioned, by means of the data processed by the image processing unit, and controlling the light penetration rate in the ZRF areas so as to reduce the brightness differential between the areas in the image.

### TECHNICAL FIELD

The present invention relates to an image quality improving apparatus, a digital imaging device including the same, and an image quality improving method, and more particularly, to an image quality improving apparatus capable of obtaining an image with excellent definition and color reproducibility even though there is present an excessive difference in brightness caused by light saturation or a light shortage for each area in one screen, a digital imaging device including the same, and an image quality improving method.

### BACKGROUND ART

Generally, a digital camera takes an image by projecting an image to an image sensor which is a charge-coupled device (CCD) or a complementary metal-oxide semiconductor (CMOS) and stores the image in a digital storage medium such as a memory card and the like.

When there is present a light saturation phenomenon caused by excessive brightness of light or on the contrary, a light shortage phenomenon caused by an excessive light shortage at a plane formed at an image sensor, the digital camera described above gives an auto white balance (AWB) function to the entire screen to improve it. Here, due to the light saturation or shortage phenomenon for each area, a problem occurs in definition and color reproducibility of the screen.

Also, in the digital camera since light except an actual visible light area acts as noise in the whole area of one screen when a difference between a visible light area and a sensitivity area occurs, a method which increases definition of a screen by transmitting light through a desired wavelength band and adjusting brightness of the light by adequately adjusting an undesired wavelength band using a color filter and takes an image or records a moving image by distributing colors is used.

As general technologies for improving image quality of a digital camera, Korean Utility Model Publication No. 20-2001-0002331 discloses “CMOS image sensor having stacked color filter as light shielding layer”, and Korean Patent Publication No. 10-2007-0078463 discloses “Apparatus and method for reducing noise from image sensor”.

However, such general technologies described above have a limitation in securing definition and color reproducibility of a taken image when there is present an excessive brightness difference in one screen due to a light saturation or light shortage phenomenon while a digital camera takes an image.

### DISCLOSURE OF INVENTION

### Technical Problem

The present invention provides a method and an apparatus for obtaining an image with excellent definition and color reproducibility by controlling partial light transmittance using a zone collected reduction filter (ZRF) installed between a lens unit and an image sensor when there is present an excessive difference in brightness caused by light saturation or a light shortage for each area in one screen. Other aspects of the present invention should be easily understood through a following description of embodiments.

### Technical Solution

One aspect of the present invention provides an image quality improving apparatus including a zone collected reduction filter (ZRF) installed between a lens unit and an image sensor to transmit light passing through the lens unit to be emitted toward the image sensor, configured as a pixel type, and adjusted in light transmittance for each of a plurality of partitioned areas by driving a unit cell using an active array, an image processor configured to process an image obtained by the image sensor into data, and a ZRF controller configured to calculate brightness of a plurality of partitioned areas in the image from the data processed by the image processor and control light transmittance with respect to the areas of the ZRF to reduce a difference in brightness between the areas in the image.

The ZRF may be installed between the image sensor and an infrared (IR) cut filter installed between the lens unit and the image sensor to lean toward the image sensor.

The ZRF may be formed as an electrochromic display (ECD) configured to be normally white, and the ZRF controller may control the light transmittance with respect to the area of the ECD at a lowest stage or may not control the light transmittance when the difference in brightness of the plurality of partitioned areas in the image from the data processed by the image processor.

The ECD may include an area corresponding to a plurality of pixels in the image sensor as one unit.

The ECD may include a substrate with a space forming pixels and partitioned into a plurality of areas and an electrochromic dye filling each of the spaces.

The ZRF controller may extract a bad light area as an area deviated from a determined brightness difference compared with total brightness in the areas of the image, may extract a correction area as an area contributing to forming the bad light area from the areas of the image sensor, may extract an area which transmits light emitted toward the correction area as an adjustment area, and may adjust light transmittance of the adjustment area to be in inverse proportion to brightness of the bad light area.

Another aspect of the present invention provides a digital imaging device including a lens unit on which light is incident, an image sensor installed behind the lens unit, a main controller configured to control an image obtained by the image sensor to be stored in a memory portion, and an image quality improver installed to control light transmittance of light emitted toward the image sensor to reduce a difference in brightness between areas in the image obtained by the image sensor. Here, the image quality improver is the image quality improving apparatus according to one embodiment of the present invention.

The digital imaging device may be any one of a portable digital camera, a closed-circuit television (CCTV) camera, a camera of a portable electronic device, a web camera, a camera module of a vision tester, and a camera module of a black box.

Still another aspect of the present invention provides an image quality improving method, including obtaining an image from an image sensor toward which light passing through a ZRF is emitted, processing the image into data, calculating brightness of a plurality of partitioned areas in the image from the data, and controlling light transmittance with respect to a plurality of partitioned areas in the ZRF to reduce a difference in brightness between the areas in the image.

The ZRF may be configured as an ECD.

The ZRF may include a substrate with a space forming pixels and partitioned into a plurality of areas and an electrochromic dye filling each of the spaces.

The controlling of the light transmittance may include extracting a bad light area as an area deviated from a determined brightness difference compared with total brightness in the areas of the image, extracting a correction area as an area contributing to forming the bad light area from the areas of the image sensor, extracting an area which transmits light emitted toward the correction area as an adjustment area, and adjusting light transmittance of the adjustment area to be in inverse proportion to brightness of the bad light area.

### Advantageous Effects

According to embodiments of the present invention, an image quality improving apparatus, a digital imaging device including the same, and an image quality improving method may obtain an image with excellent definition and color reproducibility by controlling partial light transmittance using a zone collected reduction filter (ZRF) installed between a lens unit and an image sensor when there is present an excessive difference in brightness caused by light saturation or a light shortage for each area in one screen and may reduce a decrease in resolution of the digital imaging device caused by a difference in brightness of a screen.

### BRIEF DESCRIPTION OF DRAWINGS

FIG. 1 is a configuration diagram of a digital imaging device according to one embodiment of the present invention.

FIG. 2 is a cross-sectional view illustrating a zone collected reduction filter (ZRF) in the digital imaging device according to one embodiment of the present invention.

FIG. 3 is a plan view illustrating the ZRF in the digital imaging device according to one embodiment of the present invention.

FIGS. 4 and 5 are conceptual views illustrating operations of an image quality improving apparatus according to one embodiment of the present invention.

FIG. 6 is a flowchart illustrating an image quality improving method according to one embodiment of the present invention.

### BEST MODE FOR INVENTION

Since the present invention may be variously modified and may have several embodiments, particular embodiments will be shown in the drawings and described in detail. However, it should be understood that particular embodiments do not intend to limit the present invention, the present invention includes all modifications, equivalents, and substitutes thereof and may be modified in various other forms, and the scope of the present invention is not limited to following embodiments.

Hereinafter, the embodiments according to the present invention will be described in detail with reference to the attached drawings. However, regardless of reference numerals, identical or corresponding components will be referred to as the same reference numerals and a repeated description thereof will be omitted.

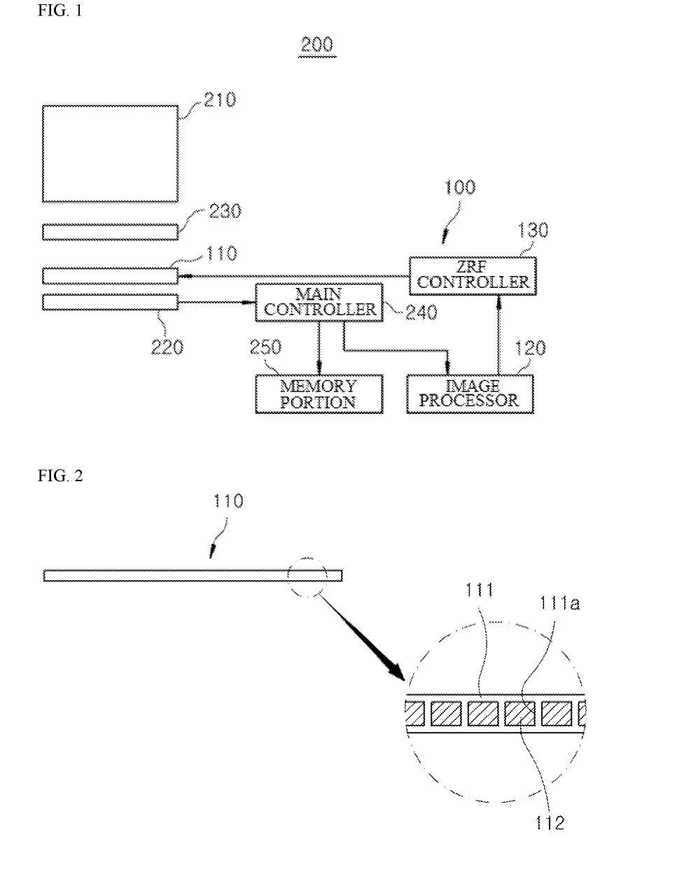

FIG. 1 is a configuration diagram of a digital imaging device according to one embodiment of the present invention.

Referring to FIG. 1, a digital imaging device 200 according to one embodiment of the present invention may include a lens unit 210, an image sensor 220, a main controller 240, and an image quality improver, may correspond to any one of a portable digital camera, a closed-circuit television (CCTV) camera, a camera for a portable electronic device, a web camera, a camera module of a vision tester, and a camera of a black box, and may further include necessary auxiliary components including a casing, a display portion, an operation portion, a battery and the like. Here, the portable digital camera may include various portable digital imaging devices including a compact digital camera, a digital single lens reflex (DSLR) camera, and a mirrorless camera.

The lens unit 210 collects light to form an image at the image sensor 220 and for this may include a single or plurality of lenses.

The image sensor 220 is installed behind the lens unit 210, may be formed as a charge-coupled device (CCD) or a complementary metal-oxide semiconductor (CMOS), and processes an image focused on a chip surface to be condensed as a charge packet on each element and processes the packet to be output and converted into an image to be displayed. Meanwhile, an infrared (IR) cut filter 230 may be installed in front of the image sensor 220 to be behind the lens unit 210. The IR cut filter 230 is a filter for blocking IR rays to overcome a limitation of an image sensor which recognizes and reacts to not only visible rays but also IR rays to be shown as a color sense different from a color sensed recognized by naked eyes.

The main controller 240 may control an image obtained by the image sensor 220 to be stored as data according to an operation signal from the operation portion or a predetermined process and to be output through the display portion as necessary.

The image quality improver is installed to control light transmittance of light emitted toward the image sensor 220 to reduce a difference in brightness between areas in an image obtained by the image sensor 220 and may be configured as an image quality improving apparatus 100 according to one embodiment of the present invention. Accordingly, the image quality improving apparatus 100 according to one embodiment of the present invention will be described replacing the image quality improver.

The image quality improving apparatus 100 according to one embodiment of the present invention may include a zone collected reduction filter (ZRF), an image processor 120, and a ZRF controller 130.

The ZRF is installed between the lens unit 210 and the image sensor 220 to transmit light passing through the lens unit 210 to be emitted toward the image sensor, configured as a pixel type, and controls light transmittance for each of a plurality of partitioned areas by driving a unit cell using an active array. The ZRF includes a plurality of pixels with adjusted light transmittance. Also, the active array is controlled by the ZRF controller 130, may be a power supply circuit which supplies power necessary for driving each unit cell formed of a single or plurality of pixels to adjust a level and an applying time of a voltage for each unit cell. Accordingly, the ZRF may be adjusted in light transmittance of a pixel by a level and applying time and the like of a voltage applied by the ZRF controller 130, for example, may be formed as an electrochromic display (ECD) 110, and additionally various display panels including a liquid crystal display (LCD) adjustable in light transmittance for each of a plurality of partitioned areas may be used.

The ECD 110 uses an element having a characteristic in which color changes when a current is applied thereto to adjust light transmittance for each pixel according to a supply time and a level of the current. An area in the ECD 110 may be a single unit with light transmittance adjusted by the ZRF controller 130, may include a single or plurality of pixels, and may be set in partitions thereof by the ZRF controller 130.

Meanwhile, the ZRF, that is, the ECD 110 may be installed between the IR cut filter 230 and the image sensor 220 to lean toward the image sensor 220 when the IR cut filter 230 is added between the lens unit 210 and the image sensor 220.

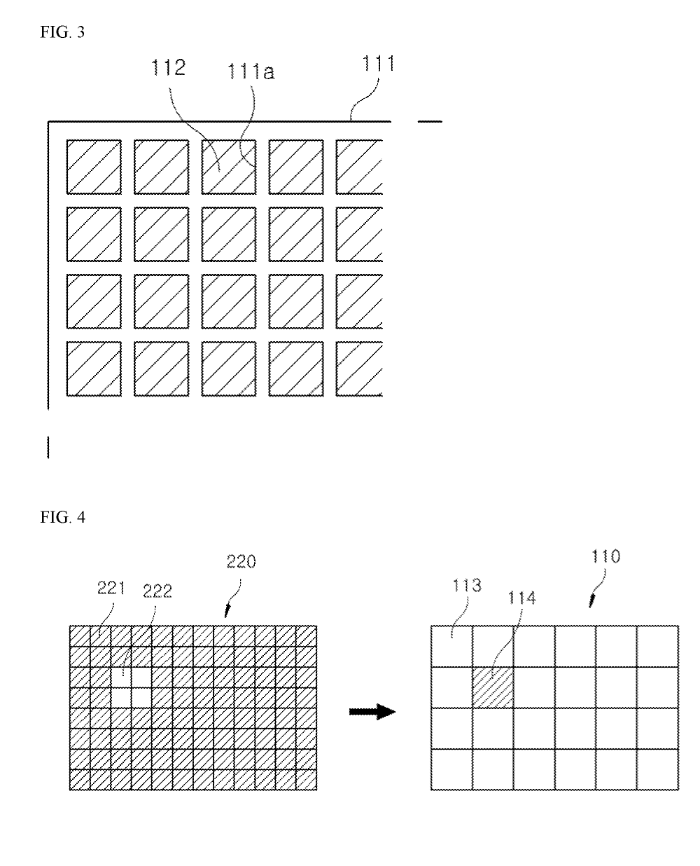

Referring to FIGS. 2 and 3, the ECD 110 may include a substrate 111 with a plurality of partitioned spaces 111a forming pixels and an electrochromic dye 112 filling for each space 111a. The substrate 111 may include a conductive pattern for supplying a current to the electrochromic dye 112 filling each of the spaces 111a under the control of the ZRF controller 130. Here, the conductive pattern may include a light transmitting material. Also, ECD 110 includes a plurality of pixels each of which may be the electrochromic dye 112 filling each of the spaces 111a of the substrate 111 and may be adjusted in light transmittance by an applying time and a level and the like of a current applied from the ZRF controller 130. Also, an area of the ECD 110 which forms a unit of being adjusted in light transmittance by the ZRF controller 130 may be, for example, formed as the electrochromic dye 112 of the single space 111a, and for another example, may be formed of the electrochromic dyes 112 filling the plurality of spaces 111a. The each area of the ECD 110 described above may be configured to correspond to a plurality of pixels in the image sensor 220 but is merely an example and may be configured to correspond to the single pixel in the image sensor 220.

The image processor 120 may process an image obtained by the image sensor 220 into data for calculating brightness for each of the plurality of partitioned areas and may output the data to the ZRF controller 130.

The ZRF controller 130 calculates the brightness of the plurality of partitioned areas in the image from the data processed by the image processor 120 and controls the light transmittance with respect to the area of the ZRF, that is, the ECD 110 to reduce a difference in brightness between areas in the image.

Meanwhile, the ZRF, that is, the ECD 110 may be configured as normally white to transmit light to have maximum brightness when a voltage is not applied. In this case, when a difference in brightness of a plurality of areas partitioned according to random settings in an image obtained by the image sensor 220 from data processed by the image processor 120 is within a normal range, for example, within a brightness difference range at a degree not to consider a decrease in image quality, the ZRF controller 130 may control light transmittance with respect to the area of the ECD 110 at a lowest stage or may not control the light transmittance. Here, the lowest stage may mean a stage for minimizing a change of the light transmittance when the light transmittance with respect to the area of the ECD 110 is set into a plurality of stages. In this case, the area of the ECD 110 corresponding to an area which generates a difference in brightness between areas in the image may be controlled.

The ZRF controller 130, for example, may extract a bad light area as an area deviated from a determined brightness difference compared with total brightness in the areas of the image obtained by the image sensor 220, may extract a correction area as an area contributing to forming the bad light area from the areas of the image sensor 220, may extract an area which transmits light emitted toward the correction area in the area of the ZRF, that is, the ECD 110 as an adjustment area, and may adjust light transmittance of the adjustment area to be in inverse proportion to brightness of the bad light area. Here, the total brightness may be a brightness grade or numerical value which indicates brightness of the whole image or may determine a brightness degree for each area of the image to be a grade or a numerical value and calculate the average thereof, and in addition thereto may be defined in various methods for calculating and determining a brightness difference. Also, the determined brightness difference may mean a grade or a numerical value which indicates a tolerance range of a brightness difference between a part or whole area and any one area.

Referring to FIG. 4, the ZRF controller 130 may extract a bad light area which corresponds to light saturation and is an excessively bright area compared with the total brightness due to, for example, a subject which emits strong light in the areas of the image obtained by the image sensor 220, may extract a correction area 222 as an area which contributes to forming the bad light area among areas 221 and 222 of the image sensor 220, may extract an area which transmits light emitted toward the correction area 222 among areas 113 and 114 of the ECD 110 as an adjustment area 114, and may adjust light transmittance of the adjustment area 114 to be decreased according to a rate set according to brightness of the bad light area. Here, the bad light area, the correction area 222, and the adjustment area 114 may be formed as a single area or a plurality of areas among areas partitioned by settings in a corresponding object. In the embodiment, for example, the correction area 222 includes four areas and the adjustment area 114 includes one area.

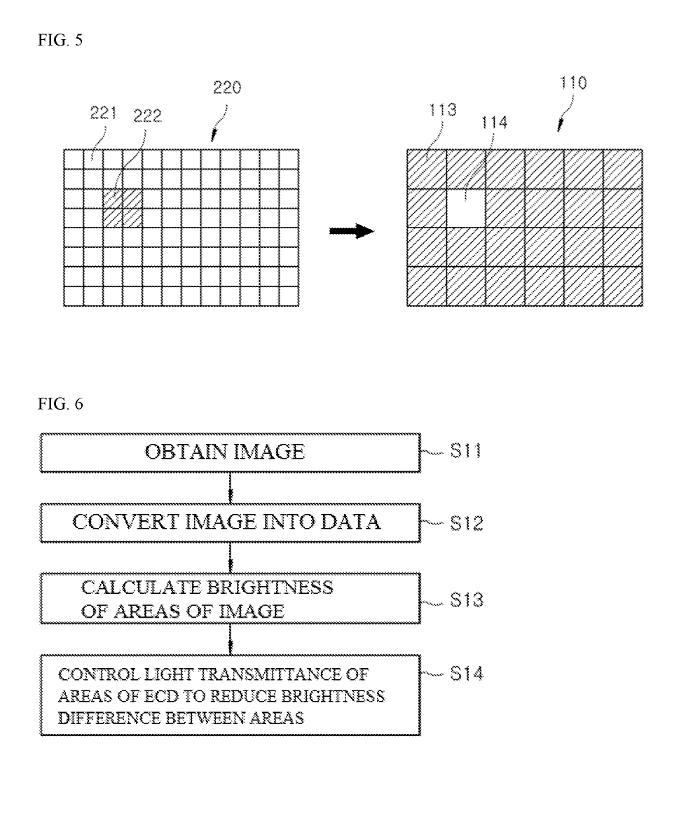

Referring to FIG. 5, the ZRF controller 130 may extract a bad light area which corresponds to a light shortage and is an excessively dark area compared with the total brightness due to, for example, a subject which is dark due to backlight in the areas of the image obtained by the image sensor 220, may extract the correction area 222 as an area which contributes to forming the bad light area among the areas 221 and 222 of the image sensor 220, may extract an area which transmits light emitted toward the correction area 222 among the areas 113 and 114 of the ECD 110 as the adjustment area 114, and may adjust light transmittance of the adjustment area 114 to be increased according to a rate set according to brightness of the bad light area.

FIG. 6 is a flowchart illustrating an image quality improving method according to one embodiment of the present invention. Since the image quality improving method according to one embodiment of the present invention is a method of using the image quality improving apparatus 100 according to one embodiment of the present invention and includes the same components with respect to the ZRF, the ECD 110, the image processor 120, and the ZRF controller 130 of the image quality improving apparatus 100 and the same embodiments thereof, a description of the components described above will be omitted.

Referring to FIG. 6, according to the image quality improving method according to one embodiment of the present invention, an image is obtained from the image sensor 220 toward which light passing through the lens unit 210 and the ZRF, that is, the ECD 110 is emitted (S11). Next, the image obtained by the image sensor 220 is processed into data by the image processor 120 (S12). The ZRF controller 130 calculates brightness of a plurality of partitioned areas in the image from the data obtained by being processed by the image processor 120 (S13). When the brightness for each area of the image is calculated, the ZRF controller 130 controls light transmittance with respect to a plurality of partitioned areas in the ZRF, that is, the ECD 110 to reduce a brightness difference between the areas in the image (S14).

The controlling of the light transmittance (S14) may include, by the ZRF controller 130, extracting a bad light area as an area deviated from a determined brightness difference compared with total brightness in the areas of the image obtained by the image sensor 220, extracting a correction area as an area contributing to forming the bad light area from the areas of the image sensor 220, extracting an area which transmits light emitted toward the correction area in the area of the ZRF, that is, the ECD 110 as an adjustment area, and adjusting light transmittance of the adjustment area to be in inverse proportion to brightness of the bad light area. A detailed description thereof is the same as the above description with reference to FIGS. 4 and 5.

When all the operations S11 to S14 are finished, an image may be obtained again by the image sensor 220 and light transmittance may be previously corrected by the ECD 110, thereby obtaining an image with high definition and excellent color reproducibility in a situation such as light saturation, a light shortage or the like.

As one example, the image quality improving method according to one embodiment of the present invention, for example, may be performed according to, for example, an operation of a user or a determined process by receiving a signal for performing an image quality improving process and may be performed as, for example, a preliminary procedure of imaging simultaneously with auto focusing or as a procedure after the auto focusing. As another example, the method may be automatically performed before imaging according to an operation of a user or a determined process by receiving a signal for performing an imaging process.

According to embodiments of the present invention, an image quality improving apparatus, a digital imaging device including the same, and an image quality improving method may obtain an image with excellent definition and color reproducibility by controlling partial light transmittance using a zone collected reduction filter (ZRF) installed between a lens unit and an image sensor when there is present an excessive difference in brightness caused by light saturation or a light shortage for each area in one screen.

While the embodiments of the present invention have been described with reference to the attached drawings as described above, various corrections and modifications may be made without departing from the technical concept of the present invention. Therefore, the scope of the present invention should not be limited to the embodiments described above and should be defined according to not only the following claims but also equivalents thereof.

### Mode for Invention

One aspect of the present invention provides an image quality improving apparatus including a zone collected reduction filter (ZRF) installed between a lens unit and an image sensor to transmit light passing through the lens unit to be emitted toward the image sensor, configured as a pixel type, and adjusted in light transmittance for each of a plurality of partitioned areas by driving a unit cell using an active array, an image processor configured to process an image obtained by the image sensor into data, and a ZRF controller configured to calculate brightness of a plurality of partitioned areas in the image from the data processed by the image processor and control light transmittance with respect to the areas of the ZRF to reduce a difference in brightness between the areas in the image.

The ZRF may be installed between the image sensor and an infrared (IR) cut filter installed between the lens unit and the image sensor to lean toward the image sensor.

The ZRF may be formed as an electrochromic display (ECD) configured to be normally white, and the ZRF controller may control the light transmittance with respect to the area of the ECD at a lowest stage or may not control the light transmittance when the difference in brightness of the plurality of partitioned areas in the image from the data processed by the image processor.

The ECD may include an area corresponding to a plurality of pixels in the image sensor as one unit.

The ECD may include a substrate with a space forming pixels and partitioned into a plurality of areas and an electrochromic dye filling each of the spaces.

The ZRF controller may extract a bad light area as an area deviated from a determined brightness difference compared with total brightness in the areas of the image, may extract a correction area as an area contributing to forming the bad light area from the areas of the image sensor, may extract an area which transmits light emitted toward the correction area as an adjustment area, and may adjust light transmittance of the adjustment area to be in inverse proportion to brightness of the bad light area.

Another aspect of the present invention provides a digital imaging device including a lens unit on which light is incident, an image sensor installed behind the lens unit, a main controller configured to control an image obtained by the image sensor to be stored in a memory portion, and an image quality improver installed to control light transmittance of light emitted toward the image sensor to reduce a difference in brightness between areas in the image obtained by the image sensor. Here, the image quality improver is the image quality improving apparatus according to one embodiment of the present invention.

The digital imaging device may be any one of a portable digital camera, a closed-circuit television (CCTV) camera, a camera of a portable electronic device, a web camera, a camera module of a vision tester, and a camera module of a black box.

Still another aspect of the present invention provides an image quality improving method, including obtaining an image from an image sensor toward which light passing through a ZRF is emitted, processing the image into data, calculating brightness of a plurality of partitioned areas in the image from the data, and controlling light transmittance with respect to a plurality of partitioned areas in the ZRF to reduce a difference in brightness between the areas in the image.

The ZRF may be configured as an ECD.

The ZRF may include a substrate with a space forming pixels and partitioned into a plurality of areas and an electrochromic dye filling each of the spaces.

The controlling of the light transmittance may include extracting a bad light area as an area deviated from a determined brightness difference compared with total brightness in the areas of the image, extracting a correction area as an area contributing to forming the bad light area from the areas of the image sensor, extracting an area which transmits light emitted toward the correction area as an adjustment area, and adjusting light transmittance of the adjustment area to be in inverse proportion to brightness of the bad light area.

### INDUSTRIAL APPLICABILITY

The present invention is industrially applicable to the field of a digital imaging device.

| | |
|---|---|
| 110: ECD | 111: Substrate |
| 111a: Space | 112: Electrochromic Dye |
| 113, 114: Areas | 120: Image Processor |
| 130: ZRF controller | 210: Lens Unit |
| 220: Image Sensor | 221, 222: Areas |
| 230: IR Cut Filter | 240: Main Controller |

250: Memory Portion

1. An image quality improving apparatus comprising:
a zone collected reduction filter (ZRF) installed between a lens unit and an image sensor to transmit light passing through the lens unit to be emitted toward the image sensor, configured as a pixel type, and adjusted in light transmittance for each of a plurality of partitioned areas by driving a unit cell using an active array;
an image processor configured to process an image obtained by the image sensor into data; and
a ZRF controller configured to calculate brightness of a plurality of partitioned areas in the image from the data processed by the image processor and control light transmittance with respect to the areas of the ZRF to reduce a difference in brightness between the areas in the image.

2. The image quality improving apparatus of claim 1, wherein the ZRF is installed between the image sensor and an infrared (IR) cut filter installed between the lens unit and the image sensor to lean toward the image sensor.

3. The image quality improving apparatus of claim 1, wherein the ZRF is formed as an electrochromic display (ECD) configured to be normally white, and
wherein the ZRF controller controls the light transmittance with respect to the area of the ECD at a lowest stage or does not control the light transmittance when the difference in brightness of the plurality of partitioned areas in the image from the data processed by the image processor.

4. The image quality improving apparatus of claim 3, wherein the ECD comprises an area corresponding to a plurality of pixels in the image sensor as one unit.

5. The image quality improving apparatus of claim 3, wherein the ECD comprises:
a substrate with a space forming pixels and partitioned into a plurality of areas; and
an electrochromic dye filling each of the spaces.

6. The image quality improving apparatus of claim 1, wherein the ZRF controller extracts a bad light area as an area deviated from a determined brightness difference compared with total brightness in the areas of the image, extracts a correction area as an area contributing to forming the bad light area from the areas of the image sensor, extracts an area which transmits light emitted toward the correction area as an adjustment area, and adjusts light transmittance of the adjustment area to be in inverse proportion to brightness of the bad light area.

7. A digital imaging device comprising:
a lens unit on which light is incident;
an image sensor installed behind the lens unit;
a main controller configured to control an image obtained by the image sensor to be stored in a memory portion; and
an image quality improver installed to control light transmittance of light emitted toward the image sensor to reduce a difference in brightness between areas in the image obtained by the image sensor,
wherein the image quality improver is the image quality improving apparatus according to claim 1.

8. The digital imaging device of claim 7, the digital imaging device is any one of a portable digital camera, a closed-circuit television (CCTV) camera, a camera of a portable electronic device, a web camera, a camera module of a vision tester, and a camera module of a black box.

9. An image quality improving method, comprising:
obtaining an image from an image sensor toward which light passing through a ZRF is emitted;
processing the image into data;
calculating brightness of a plurality of partitioned areas in the image from the data; and
controlling light transmittance with respect to a plurality of partitioned areas in the ZRF to reduce a difference in brightness between the areas in the image.

10. The method of claim 9, wherein the ZRF is configured as an ECD.

11. The method of claim 10, wherein the ZRF comprises:
a substrate with a space forming pixels and partitioned into a plurality of areas; and
an electrochromic dye filling each of the spaces.

12. The method of claim 9, wherein the controlling of the light transmittance comprises:
extracting a bad light area as an area deviated from a determined brightness difference compared with total brightness in the areas of the image;
extracting a correction area as an area contributing to forming the bad light area from the areas of the image sensor;
extracting an area which transmits light emitted toward the correction area as an adjustment area; and
adjusting light transmittance of the adjustment area to be in inverse proportion to brightness of the bad light area.
